(19) United States
(12) Patent Application Publication
(10) Pub. No.: US 2005/0246930 A1
(43) Pub. Date: Nov. 10, 2005

(54) Hang level suspension system

(76) Inventor: Perry Shaffer, Folsom, CA (US)

Correspondence Address: PERRY SHAFFER, APARTMENT 16, 1212 BIDWELL STREET, FOLSOM, CA, 95630, US

(21) Appl. No.: 11/091,670

(22) Filed: Mar. 28, 2005

Related U.S. Application Data
(60) Provisional application No. 60/557,753, filed on Mar. 31, 2004.

(51) Int. Cl. A47G 1/06; A47G 1/16; B62D 21/00; B62D 21/15; B62D 21/16; B62D 21/17; B62D 24/00

(52) U.S. Cl. 40/713; 40/757

(57) ABSTRACT

A Hang Level Suspension System, hereafter known as Suspension System, for articles such as frames for pictures, mirrors, or other articles to be supported on a wall in a level attitude. The Suspension System for the frame includes two hangers, which are attached to a wall in a level attitude, two suspension elements comprising two washers, two equal lengths of chain and two eye-screws. These two suspension elements are mounted, one on each side of the frame, at a precise distance from the top of the frame. Two hangers are spaced apart, on the wall in a level attitude, the same distance as the suspension elements attached to the back of the frame. When the Suspension System is completed, a washer of the Suspension System is placed on the corresponding hanger on the wall. The suspended article will hang level at all times.

### FIELD OF INVENTION

This invention is directed to a suspension system for hanging of pictures, mirrors, or other articles on a wall in a level orientation.

### DESCRIPTION OF PRIOR ART

Usually, a device to hang a picture frame on a wall consists of a loop of wire attached to the back of the frame with two eye screws plus a wall mounted hanger. The loop of wire is placed over the wall hanger projection and the frame is leveled manually. The problem with this support system is the frame must be manually returned to level each time the article is touched for dusting or cleaning.

U.S. Pat. No. 4,244,549 by C. T. Oldfield, discloses a wall hanging device which has a rectangular plate with three, equally spaced holes on a horizontal centerline. A loop of wire is threaded through the outer holes and the ends of the wire are attached to the frame. A wall support nail through the center hole supports the plate and frame assembly. After initially leveling the frame, friction maintains the frame in a level attitude. However, if the frame is tilted, friction will maintain the tilted attitude.

U.S. Pat. No. 5,437,429 by J. Atlas, discloses a picture hook hanger, is comprised of a wall anchored retention member and an object holding member. The wall-anchored member comprises means for permitting the fixed position anchoring thereof to a wall with a nail. The object holding member comprises means for holding objects thereon, preferably with two hook elements and a means for permitting floating engagement with the nail. Draping the wire on the back of the frame over the hooks and adjusting the picture to level completes the installation. A problem with this design is that the friction of the wire on the hooks is the force that holds the picture level. If the picture is moved, the center of gravity of the frame may be such that the picture does not hang level.

U.S. Pat. No. 6,318,698 B1 by C. Hansen, discloses a suspension device comprising a base element which is fastened to the backside of a picture frame, an elongated element and a positioning structure for adjustable positioning of the elongated element relative to the base element. Normally, two suspension devices are used per frame. The emphasis of the Hansen invention is on the structure for adjustment of the elongated element. No description of the wall support member is provided. Also, no description of the complete support system is shown in the nine figures.

The current invention overcomes the shortcomings of the above disclosures.

### BRIEF DESCRIPTION OF THE DRAWINGS

FIG. 1 is a side view of one-half of the Suspension System of the invention showing a frame front view (115F) and a back view (115B), which includes an eye-screw (112), a chain (111), a washer (110), a hanger (113), a nail (114) and a wall (116).

FIG. 2 shows two hangers (113) and two nails (114) mounted level on a wall (116). The hangers (113) are suspended approximately the same distance as the two-suspension elements (105) shown in FIG. 3.

FIG. 3 shows two suspension elements (105) attached to the backside of a frame (115B) at equal distances from the top of the frame (115B).

FIG. 4 shows the front side of a frame (115F) hung on a wall (116). Attached to the backside of the frame (115B) are two suspension elements (105). In addition, two hangers (113) are attached to a wall (116) by nails (114).

FIG. 5 is a typical washer (110) that is used to attach the chain (111) of the suspension element (105) to a hanger (113).

FIG. 6 is a washer design, which has one large hole for attaching to the hanger (113) and five small holes at varying distances for mounting on the chain (111). These varying holes could be used to correct misalignment of the frame if the suspension element (105) is incorrectly mounted.

FIG. 7 is a washer design, which has one large hole for attaching to the hanger (113) and a small hole for attaching to the chain (111) of the suspension element (105).

FIG. 8 is the chain (111) in which the top link is bent in an “S” shape for mounting on the hanger.

FIG. 9 is an alternate support element (106) using a cable (117) instead of a chain (111).

FIG. 10 is an alternate design for heavy frames using a commercially available heavy-duty frame attachment (117) instead of an eye-screw (112).

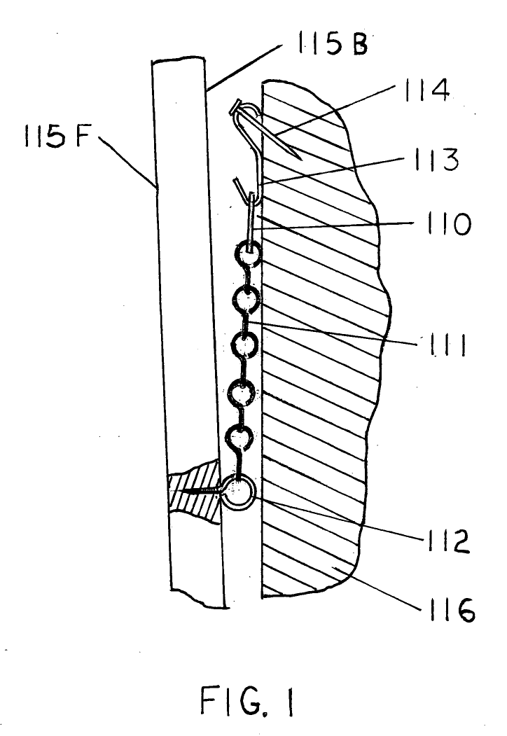

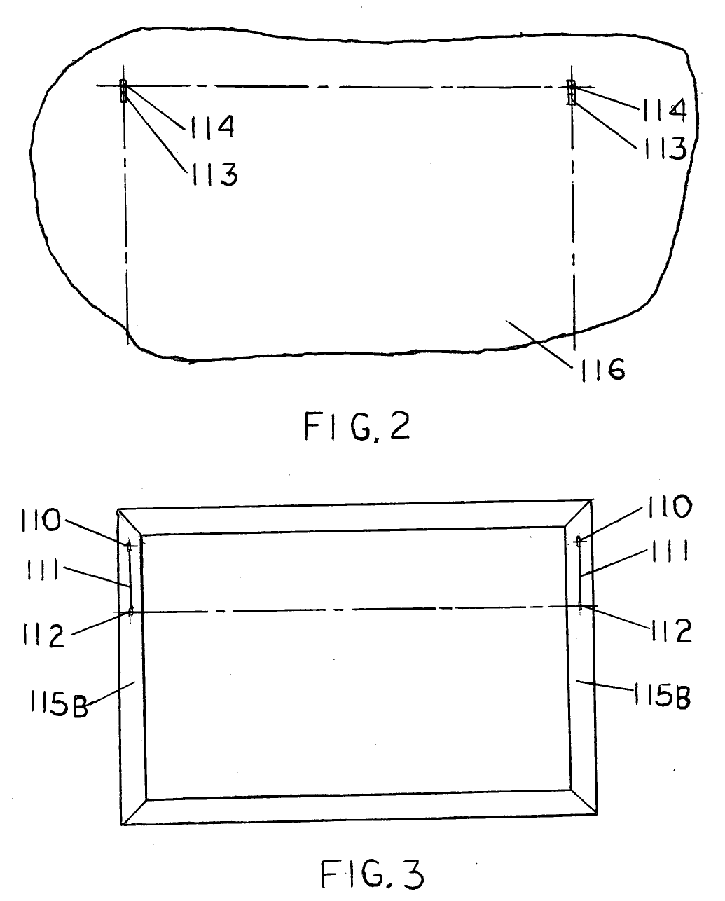

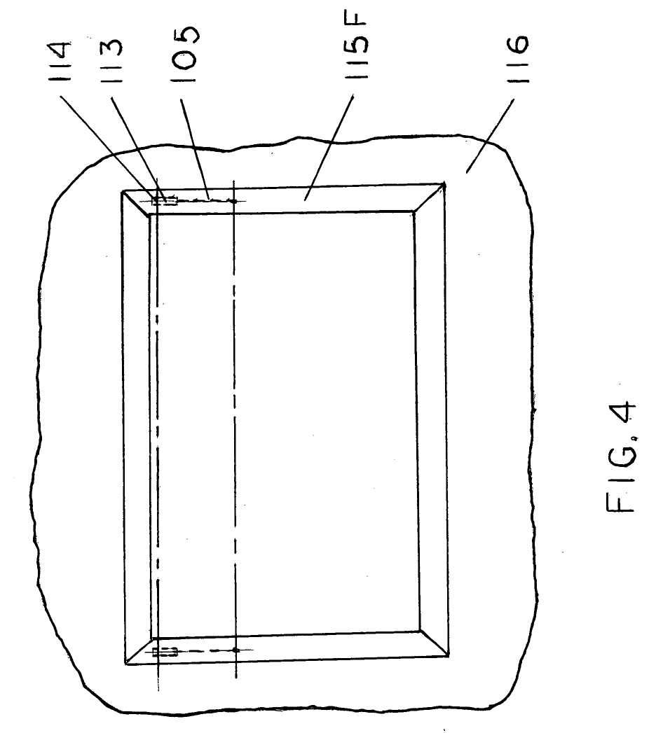

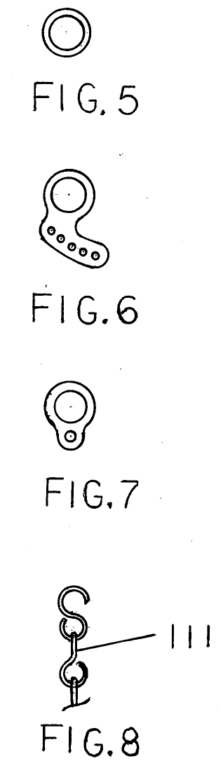

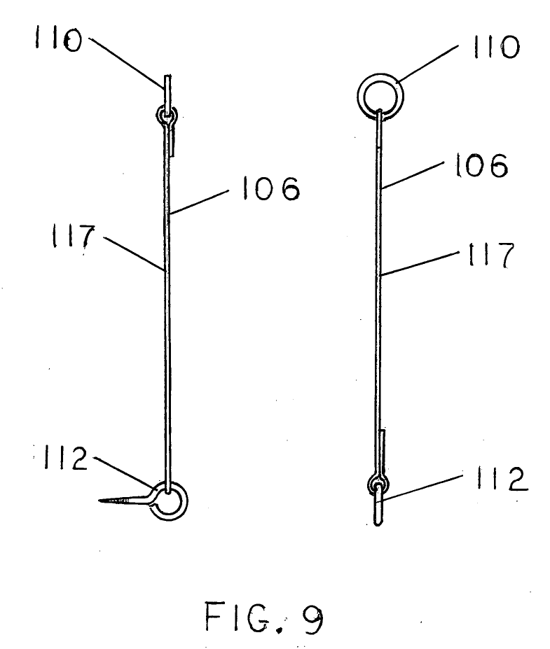

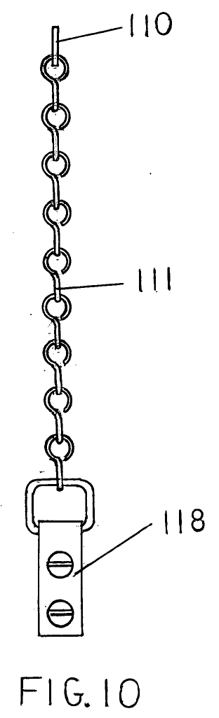

The following is a list of items called out on FIGS. 1 through 10;
1. (105)—suspension element;
2. (106)—alternate suspension element;
3. (110)—washer;
4. (111)—chain;
5. (112)—eye-screw;
6. (113)—hanger;
7. (114)—nail;
8. (115)—frame;
9. (116)—wall;
10. (117)—cable;
11. (118)—heavy duty frame hangers.

### DETAILED DESCRIPTION OF PREFERRED EMBODIMENTS OF THE INVENTION

FIG. 1 shows a first embodiment of the invention named Hang Level Suspension System. This Suspension System embodies two hangers (113) hung level on a wall (116) by two nails (114) at approximately the same distance as the suspension elements (105) attached to the back of the frame (115B) at equal distance from the top of the frame (105).

When the two washers (110) of the two suspension elements (105) are mounted on the hangers (113), which are attached to a wall (116), the frame (115) will hang level. The frame (115), when touched accidentally, or for dusting will automatically return to level.

1. A Suspension System for an article to hang level on a vertical surface comprising;
two suspension elements;
two hangers;
a frame.
Each suspension element is secured to the frame and attached to a hanger.

2. As in claim 1, wherein said suspension element comprises a washer, a predetermined length of chain and an eye-screw.

3. As in claim 1, wherein the length of the chain is predetermined by the size of the article to be hung.

4. As in claim 2, wherein the strength or size of the links in the chain is predetermined by the weight of the article to be hung on the wall.

5. As in claim 1, wherein the size of the two wall hangers is predetermined by the weight of the article to be hung on the wall.

6. As in claim 1, a Suspension System for an article to hang level on a wall comprises two suspension elements installed on the back of a frame at the same distance from the upper edge of the frame on both sides of the frame.

7. As in claim 1, a Suspension System for an article to hang level on a wall comprises two suspension elements installed on the back of a frame and two wall hangers mounted on a wall at the same distance the suspension elements are mounted on the frame. The two wall hangers are installed level by using either a level, or laser-leveling device.
